(19) United States
(12) Patent Application Publication
(10) Pub. No.: US 2025/0183281 A1
(43) Pub. Date: Jun. 5, 2025

(54) BATTERY

(71) Applicant: TOYOTA JIDOSHA KABUSHIKI KAISHA, Toyota-shi (JP)

(72) Inventor: Takuya MATSUYAMA, Miyoshi-shi (JP)

(73) Assignee: TOYOTA JIDOSHA KABUSHIKI KAISHA, Toyota-shi (JP)

(21) Appl. No.: 18/798,826

(22) Filed: Aug. 9, 2024

(30) Foreign Application Priority Data
Dec. 5, 2023 (JP) 2023-205727

(51) Int. Cl. H01M 4/38; H01M 4/02; H01M 4/36; H01M 10/052; H01M 10/0562

(52) U.S. Cl. CPC H01M 4/386; H01M 4/366; H01M 10/052; H01M 10/0562; H01M 2004/021; H01M 2004/027

(57) ABSTRACT

In the present disclosure, the problem is solved by providing a battery including: a positive electrode layer containing a positive electrode active material; a negative electrode layer containing a negative electrode active material; and an electrolyte layer containing an electrolyte, and disposed between the positive electrode layer and the negative electrode layer, wherein the negative electrode layer contains a Si-based negative electrode active material as the negative electrode active material, the Si-based negative electrode active material has a pore inside a primary particle, and a ratio of a negative electrode capacity to a positive electrode capacity is 2.5 or more.

### CROSS-REFERENCE TO RELATED APPLICATION

This application claims priority to Japanese Patent Application No. 2023-205727 filed on Dec. 5, 2023, incorporated herein by reference in its entirety.

### BACKGROUND

### 1. Technical Field

The present disclosure relates to a battery.

### 2. Description of Related Art

Batteries are being actively developed in these years. For example, in the automotive industry, batteries to be used in battery electric vehicles (BEVs), plug-in hybrid electric vehicles (PHEVs), and hybrid electric vehicles (HEVs) are being developed. Besides, various examinations are being made on materials used in batteries.

For example, Japanese Unexamined Patent Application Publication No. 2020-113547 discloses a negative electrode material containing a silicon oxide for a lithium ion secondary battery. Besides, Japanese Unexamined Patent Application Publication No. 2023-098419 discloses a secondary battery using a silicon negative electrode active material.

### SUMMARY

Si is known as a negative electrode active material having a high capacity. On the other hand, since Si has a high capacity, for example, when an internal short circuit occurs in the battery, the calorific value easily increases.

The present disclosure is proposed in consideration of these actual circumstances, and a main object is to provide a battery having a suppressed calorific value.

[1] A battery including: a positive electrode layer containing a positive electrode active material; a negative electrode layer containing a negative electrode active material; and an electrolyte layer containing an electrolyte, and disposed between the positive electrode layer and the negative electrode layer, wherein the negative electrode layer contains a Si-based negative electrode active material as the negative electrode active material, the Si-based negative electrode active material has a pore inside a primary particle, and a ratio of a negative electrode capacity to a positive electrode capacity is 2.5 or more.

[2] The battery according to [1], wherein the ratio is 5.0 or less.

[3] The battery according to [1] or [2], wherein the Si-based negative electrode active material has a silicon clathrate crystalline phase.

[4] The battery according to [3], wherein the Si-based negative electrode active material has, as the crystalline phase, a type II silicon clathrate crystalline phase.

[5] The battery according to any one of [1] to [4], wherein a proportion of the Si-based negative electrode active material in the negative electrode layer is 45% by weight or more.

The present disclosure exerts an effect that a calorific value of a battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic sectional view illustrating an example of a battery of the present disclosure;

FIG. 1B is a schematic sectional view illustrating another example of the battery of the present disclosure;

FIG. 2A is a schematic perspective view illustrating a crystalline phase of Si;

FIG. 2B is a schematic perspective view illustrating another crystalline phase of Si;

FIG. 2C is a schematic perspective view illustrating another crystalline phase of Si; and

FIG. 3 is a graph illustrating results of a cycle test performed in Comparative Example 1-4.

### DETAILED DESCRIPTION OF EMBODIMENTS

A battery according to the present disclosure will now be described in detail. It is noted that a Si-based negative electrode active material of the present disclosure has a pore inside a primary particle, and hence the Si-based negative electrode active material is herein referred to as porous Si (p-Si) in some cases. Besides, when the Si-based negative electrode active material (porous Si) of the present disclosure has a clathrate crystalline phase, it is referred to as porous clathrate Si (pc-Si) in some cases.

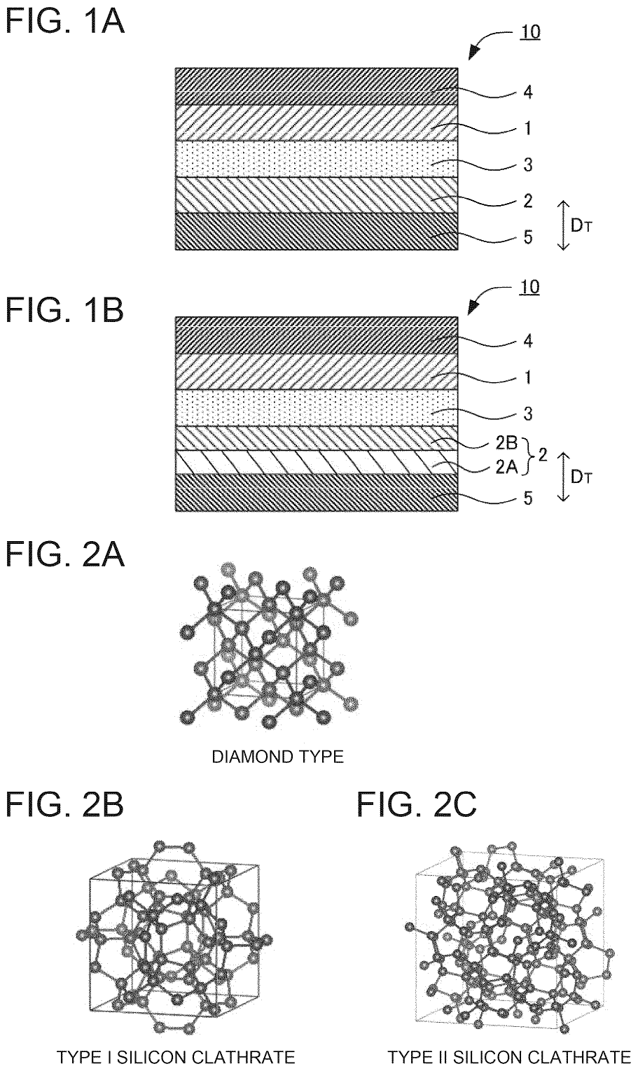

FIGS. 1A and 1B are schematic sectional views illustrating examples of a battery of the present disclosure. The battery 10 illustrated in FIGS. 1A and 1B includes a positive electrode layer 1 containing a positive electrode active material, a negative electrode layer 2 containing a negative electrode active material, and an electrolyte layer 3 containing an electrolyte, and disposed between the positive electrode layer 1 and the negative electrode layer 2. In particular, in the battery 10 of the present disclosure, the negative electrode layer 2 contains, as the negative electrode active material, a Si-based negative electrode active material, and the Si-based negative electrode active material has a pore inside a primary particle. Besides, in the battery 10, a ratio of the negative electrode capacity to the positive electrode capacity is 2.5 or more. In the battery of the present disclosure, the negative electrode layer 2 may be a single layer as illustrated in FIG. 1A, or the negative electrode layer 2 may be a bilayer (including a first negative electrode layer 2A and a second negative electrode layer 2B) as illustrated in FIG. 1B, which will be described later.

According to the present disclosure, the negative electrode layer contains, as the negative electrode active material, the Si-based negative electrode active material having a pore inside the primary particle, and in addition, the ratio of the negative electrode capacity to the positive electrode capacity is 2.5 or more, and therefore, a battery having a suppressed calorific value is obtained.

Although Si is an active material having a high capacity, a portion in which a reaction with a carrier ion such as a Li ion is concentrated is easily formed, and hence, the reaction with the carrier ion might occur unevenly in the negative electrode active material. When the reaction with the carrier ion occurs unevenly, namely, when there is a portion in which the reaction is concentrated, the temperature easily increases at the occurrence of an internal short circuit.

On the contrary, the Si-based negative electrode active material of the present disclosure has a pore inside the primary particle. When such a pore is present, the specific surface area of the active material is increased, and the area in which the active material can contact an electrolyte is increased. Therefore, when the Si-based negative electrode active material of the present disclosure is used, the reaction with the carrier ion can be inhibited from concentratedly occurring in a part of the active material. Besides, in the battery of the present disclosure, the ratio (capacity ratio) of the negative electrode capacity to the positive electrode capacity is 2.5 or more. When the capacity ratio is sufficiently large, the negative electrode active material is present in the negative electrode layer in a sufficient amount for the carrier ion moving from the positive electrode. Therefore, the reaction between the negative electrode active material and the carrier ion can be inhibited from locally occurring in the negative electrode layer, and thus, the reaction can be made to evenly occur in the entire negative electrode layer. As a result, a calorific value of the battery can be suppressed.

Besides, since the capacity ratio is 2.5 or more, an effect of favorable cycle characteristics can be obtained as described in Examples below.

### 1. Negative Electrode Layer

The negative electrode layer of the present disclosure contains the negative electrode active material. In particular, the negative electrode layer of the present disclosure contains a prescribed Si-based negative electrode active material.

### (1) Si-Based Negative Electrode Active Material

The Si-based negative electrode active material may be simple Si, may be an alloy containing Si as a principal component (Si alloy), or may be a Si oxide. The proportion of Si element in the Si alloy is, for example, 50 mol % or more and 95 mol % or less.

The Si-based negative electrode active material has a pore inside the primary particle. It can be confirmed by observation with a scanning electron microscope (SEM) that the active material has a pore. Besides, the porosity is not especially limited, and is, for example, 4% or more, and may be 10% or more. The porosity is, for example, 40% or less, and may be 20% or less. The porosity can be obtained, for example, by the following procedures. First, a negative electrode layer containing a Si-based negative electrode active material is subjected to ion milling to expose a section. The section is observed with an SEM to obtain a photograph of a particle. Based on the thus obtained photograph, image analysis software is used to make a distinction between a silicon portion and a pore portion for binarization. Areas of the silicon portion and the pore portion are obtained, and a porosity (%) is calculated in accordance with the following equation:

$$Porosity ( \% ) = 100 \times ( pore portion area ) / ( ( silicon portion area ) + ( pore portion area ) )$$

Besides, an amount of pores having a pore diameter of 50 nm or less in the porous Si is, for example, 0.05 cc/g or more and 0.30 cc/g or less. Further, the BET specific surface area of the porous Si is, for example, 20 m²/g or more and 200 m²/g or less.

An example of a method for producing porous Si includes a method in which an alloy of Li and Si (LiSi alloy) is produced, and then Li is removed from the LiSi alloy. The LiSi alloy can be obtained, for example, by mixing Li and Si. The ratio of Li to Si (Li/Si) is, for example, 1.0 or more, may be 2.0 or more, may be 3.0 or more, or may be 4.0 or more. On the other hand, the Li/Si is, for example, 8.0 or less. An example of a method for removing Li from a LiSi alloy includes a method in which the LiSi alloy is reacted with a Li extractant. Examples of the Li extractant include alcohols such as methanol, ethanol, 1-propanol, 1-butanol, 1-pentanol, and 1-hexanol; and acids such as acetic acid, formic acid, propionic acid, and oxalic acid.

Here, FIGS. 2A, 2B, and 2C are schematic perspective views illustrating crystalline phases of Si. In general, Si has a diamond crystalline phase as illustrated in FIG. 2A. On the contrary, the Si-based negative electrode active material of the present disclosure may have a silicon clathrate crystalline phase as illustrated in FIG. 2B and FIG. 2C. In the diamond crystalline phase illustrated in FIG. 2A, a tetrahedron is formed by a plurality of Si elements. The tetrahedron does not have, inside thereof, a space capable of including a metal ion such as a Li ion. On the other hand, in type I and II silicon clathrate crystalline phases illustrated in FIGS. 2B and 2C, skeleton atoms have a cage-shaped structure (cage), and a metal ion such as a Li ion can enter the cage, and hence, the reaction of the Li ion can be made more even. Therefore, in the Si-based negative electrode active material (pc-Si) having a pore inside the primary particle, and having the silicon clathrate crystalline phase, the calorific value of the battery can be suppressed more largely.

The Si-based negative electrode active material may have a type I silicon clathrate crystalline phase, or may have a type II silicon clathrate crystalline phase. In particular, the active material preferably has the type II silicon clathrate crystalline phase as a main phase. The term “main phase” refers to that a peak belonging to the crystalline phase has largest diffraction intensity among peaks observed in X-ray diffraction measurement. The proportion of the type II silicon clathrate crystalline phase included in the Si-based negative electrode active material is, for example, 80% by weight or more, may be 85% by weight or more, may be 90% by weight or more, or may be 95% by weight or more. The proportion of the type II silicon clathrate crystalline phase included in the Si-based negative electrode active material may be 100% by weight, or may be less than 100% by weight. The proportion of a crystalline phase can be obtained by employing a reference intensity ratio (RIR) method.

On the other hand, the Si-based negative electrode active material of the present disclosure may have, or may not have the diamond silicon (crystalline Si) crystalline phase. The phrase “not to have a crystalline phase” refers to that a peak of the crystalline phase is not observed in X-ray diffraction measurement. The proportion of the diamond silicon crystalline phase included in the active material is, for example, less than 3% by weight, may be 2.5% by weight or less, or 2% by weight or less. On the other hand, the proportion of the diamond silicon crystalline phase included in the active material may be 0% by weight, may be more than 0% by weight, or may be 0.1% by weight or more.

An example of a method for producing porous clathrate Si includes a method in which a Na—Si alloy is produced by mixing the porous Si and a Na source such as NaH and heating the resultant, and the Na amount in the Na—Si alloy is reduced by heating the Na—Si alloy to generate a silicon clathrate crystalline phase. A more specific method will be described in Examples below.

The composition of the porous clathrate Si is not especially limited, and is preferably represented by NaₓSi₁₃₆, wherein 0≤x≤24. x may be zero, or larger than zero. On the other hand, x may be 20 or less, may be 10 or less, or may be 5 or less. The composition of an electrode active material can be obtained by, for example, EDX, XRD, XRF, ICP, or atomic absorption spectrophotometry. Besides, the Na amount in the active material may be 0% by weight, or may be larger than 0% by weight. In the latter case, the Na amount in the active material is, for example, 0.1% by weight or more, and may be 0.5% by weight or more, or may be 1.0% by weight or more. On the other hand, the Na amount in the active material is, for example, 10% by weight or less, and may be 5% by weight or less, or may be 3% by weight or less.

The Si-based negative electrode active material of the present disclosure may be a primary particle, or may be a secondary particle formed by agglomeration of the primary particle. The average particle size (D₅₀) of the Si-based negative electrode active material is not especially limited, and is, for example, 0.1 μm or more and 50 μm or less, and may be 0.5 μm or more and 30 μm or less. The average particle size (D₅₀) refers to a particle size corresponding to a cumulative volume of 50% measured with a laser diffraction particle size distribution analyzer.

### (2) Negative Electrode Layer

In the battery of the present disclosure, the ratio (capacity ratio) of the negative electrode capacity to the positive electrode capacity is 2.5 or more. The capacity ratio may be 3.0 or more, may be 3.2 or more, or may be 3.5 or more. On the other hand, the capacity ratio is, for example, 5.0 or less, may be 4.5 or less, may be 4.0 or less, or may be 3.8 or less. The capacity ratio can be calculated by a method described in Examples below.

The negative electrode layer may contain, if necessary, at least one of a conductive aid, a binder, and an electrolyte. Examples of the conductive aid include a carbon material, a metal particle, and a conductive polymer. Examples of the binder include a fluorine-based binder, a rubber-based binder, and an acrylic-based binder. Examples of the electrolyte include electrolytes described in “3. Electrolyte Layer” below.

The proportion of the Si-based negative electrode active material in the negative electrode layer is, for example, 45% by weight or more, may be 50% by weight or more, or may be 60% by weight or more. On the other hand, the proportion of the Si-based negative electrode active material is, for example, 80% by weight or less, and may be 70% by weight or less. Here, when the negative electrode layer contains a solid electrolyte, the negative electrode layer generally contains the Si-based negative electrode active material and the solid electrolyte as principal components. Therefore, the proportion of the Si-based negative electrode active material can be regarded as the proportion of the Si-based negative electrode active material to the sum of the Si-based negative electrode active material and the solid electrolyte.

The thickness of the negative electrode layer is not especially limited, and is, for example, 0.5 μm or more and 1000 μm or less.

As illustrated in FIG. 1A, the negative electrode layer 2 may be a single layer. On the other hand, as illustrated in FIG. 1B, the negative electrode layer 2 may have the first negative electrode layer 2A, and the second negative electrode layer 2B disposed on the side of the first negative electrode layer 2A closer to the electrolyte layer 3 in a thickness direction Dt. In this case, the proportion of the Si-based negative electrode active material in the first negative electrode layer 2A is larger than the proportion of the Si-based negative electrode active material in the second negative electrode layer 2B. The proportions of the Si-based negative electrode active material in the first negative electrode layer and in the second negative electrode layer are the same as the proportion of the Si-based negative electrode active material in the negative electrode layer. Assuming that the proportion of the Si-based negative electrode active material in the first negative electrode layer is X and that the proportion of the Si-based negative electrode active material in the second negative electrode layer is Y, the ratio of X to Y (X/Y) is, for example, 1.1 or more and 1.5 or less.

### 2. Positive Electrode Layer

The positive electrode layer of the present disclosure contains at least the positive electrode active material.

An example of the positive electrode active material includes an oxide active material. Examples of the oxide active material include layered rock salt-type active materials such as LiCoO₂, LiMnO₂, LiNiO₂, LiVO₂, LiNi_{0.33}Co_{0.33}Mn_{0.33}O₂, and LiNi_{0.8}Co_{0.15}Al_{0.05}O₂; spinel-type active materials such as LiMn₂O₄, Li₄Ti₅O₁₂, and Li(Ni_{0.5}Mn_{1.5})O₄; and olivine-type active materials such as LiFePO₄, LiMnPO₄, LiNiPO₄, and LiCoPO₄. Alternatively, sulfur(S) may be used as the positive electrode active material.

The positive electrode active material may be a coated positive electrode active material having a core particle, a first coating layer formed on the surface of the core particle, and a second coating layer formed on the surface of the first coating layer. The first coating layer contains an oxide solid electrolyte such as LiNbO₃. The second coating layer contains a sulfide solid electrolyte such as Li₂S—P₂S₅. The thicknesses of the first coating layer and the second coating layers are respectively, for example, 1 nm or more and 10 μm or less. It is noted that the positive electrode active material may be an active material not including the second coating layer but including the core particle and the first coating layer.

The shape of the positive electrode active material is, for example, a particle shape. The average particle size (D₅₀) of the positive electrode active material (core particle) is not especially limited, and is, for example, 10 nm or more and 50 μm or less, may be 1 μm or more and 10 μm or less, or may be 2.5 μm or more and 6.0 μm or less. The average particle size (D₅₀) has been described above.

The positive electrode layer may contain, if necessary, at least one of a conductive aid, a binder, and an electrolyte. The conductive aid, the binder, and the electrolyte are the same as those described in “1. Negative Electrode Layer” above.

The proportion of the positive electrode active material in the positive electrode layer is, for example, 65% by weight or more and 85% by weight or less. It is noted that the proportion of the positive electrode active material can be regarded, similarly to the proportion of the Si-based negative electrode active material, as the proportion of the positive electrode active material to the sum of the positive electrode active material and the solid electrolyte.

The thickness of the positive electrode layer is not especially limited, and is, for example, 0.5 μm or more and 1000 μm or less.

### 3. Electrolyte Layer

The electrolyte layer of the present disclosure is a layer containing an electrolyte, and disposed between the positive electrode layer and the negative electrode layer.

The electrolyte may be a solid electrolyte, or a liquid electrolyte. The solid electrolyte may be an organic solid electrolyte such as a gel electrolyte, or an inorganic solid electrolyte such as a sulfide solid electrolyte, or an oxide solid electrolyte. In particular, the solid electrolyte is preferably a sulfide solid electrolyte. This is because ionic conductivity is high. Here, a battery having a solid electrolyte layer containing an inorganic solid electrolyte is designated as a solid-state battery in general.

The sulfide solid electrolyte usually contains at least Li element and S element. The sulfide solid electrolyte preferably further contains M element, wherein M is at least one of P, As, Sb, Si, Ge, Sn, B, Al, Ga, and In. The sulfide solid electrolyte may contain a halogen element such as F, Cl, Br, or I.

On the other hand, the liquid electrolyte (electrolytic solution) contains, for example, a supporting salt such as LiPF₆, and a solvent such as a carbonate-based solvent.

The electrolyte layer may include a nonwoven fabric. Examples of the material of the nonwoven fabric include polyester-based resins such as polyethylene terephthalate (PET), polyolefin-based resins such as polyethylene (PE), and polyamide-based resins such as nylon.

When the electrolyte layer includes the nonwoven fabric, the electrolyte is disposed inside the nonwoven fabric. For example, the electrolyte can be disposed inside the nonwoven fabric by applying a slurry containing the electrolyte onto the nonwoven fabric.

The thickness of the electrolyte layer is not especially limited, and is, for example, 0.1 μm or more and 1000 μm or less, may be 1 μm or more and 100 μm or less, or may be 10 μm or more and 50 μm or less, or may be 15 μm or more and 30 μm or less.

### 4. Battery

As illustrated in FIGS. 1A and 1B, the battery of the present disclosure usually includes a positive electrode current collector 4 for collecting electrons of the positive electrode layer 1, and a negative electrode current collector 5 for collecting electrons of the negative electrode layer 2. Examples of the material of the positive electrode current collector include SUS, aluminum, nickel, iron, titanium, and carbon. Besides, the positive electrode current collector may be a current collector having a carbon layer containing alumina as described in Examples below, or may be a current collector including a resin coat layer formed on a metal foil. Examples of the material of the negative electrode current collector include SUS, iron, nickel, and carbon.

The battery of the present disclosure may have an exterior body for housing an electrode body including the positive electrode layer, the electrolyte layer, and the negative electrode layer. Examples of the exterior body include a case-type exterior body, and a laminate exterior body.

The battery of the present disclosure is typically a lithium ion secondary battery. Besides, the battery of the present disclosure may be a liquid-state battery containing an electrolytic solution as the electrolyte, or may be a solid-state battery containing a solid electrolyte as the electrolyte. An example of use of the battery includes a power source for a vehicle such as a hybrid electric vehicle (HEV), a plug-in hybrid electric vehicle (PHEV), a battery electric vehicle (BEV), a gasoline vehicle, or a diesel vehicle. Besides, the battery of the present disclosure may be used as a power source for a mobile object except for a vehicle (such as a railway vehicle, a ship or boat, or an aircraft), or may be used as a power source for an electric product such as an information processor.

It is noted that the present disclosure is not limited to the embodiment described above. The embodiment is merely an example, and any one of those having substantially the same configuration as the technical idea within the scope of claims of the present disclosure, and exerting similar function and effects are encompassed in the technical scope of the present disclosure.

### Example 1-1

### Production of Negative Electrode Active Material

An active material (pc-Si) having a pore inside a primary particle, and having a silicon clathrate crystalline phase was produced as a negative electrode active material by the following method.

As a Si source, Si particles (Si powder having no pore inside a primary particle, SIE23PB manufacture by Kojundo Chemical Laboratory Co., Ltd.) were prepared. A Na—Si alloy was produced by using this Si source, and using NaH as a Na source. As NaH, one precedently washed with hexane was used. The Na source and the Si source were weighed to a molar ratio of 1.05:1, and were mixed with a cutter mill. The resultant mixture was heated in a heating furnace at 400° C. for 40 hours in an Ar atmosphere, and thus, a Na—Si alloy in the form of a powder was obtained.

A silicon clathrate production process was performed by a solid phase method using the thus obtained Na—Si alloy, and using AlF₃ as a Na trapping agent. The Na—Si alloy and AlF₃ were weighed to a molar ratio of 1:0.35, and were mixed with a cutter mill to obtain a reaction raw material. The thus obtained reaction raw material in the form of a powder was put in a stainless steel reaction container, and was reacted by heating in a heating furnace under conditions of Ar atmosphere, 310° C., and 60 hours. The thus obtained reaction product probably contains an objective active material, and by-products of NaF and Al. This reaction product was washed with a mixed solvent obtained by mixing HNO₃ and H₂O in a volume ratio of 90:10. Thus, the by-products contained in the reaction product were removed. After the washing, the resultant was filtered, and a filtered solid content was dried at 120° C. for more than 3 hours, and thus, an active material in the form of a powder was obtained.

### Production of Negative Electrode

The active material (pc-Si), a sulfide solid electrolyte (SE: Li₂S—P₂S₅), a conductive aid (VGCF), a PVDF-based binder, and butyl butyrate were stirred in an ultrasonic dispersion device to produce a negative electrode mixture (negative electrode slurry). Here, in the negative electrode slurry, a weight ratio between the negative electrode active material and the sulfide solid electrolyte was 65:35. This negative electrode slurry was applied by a blade method onto a negative electrode current collector (Ni foil), and the resultant was dried on a hot plate at 100° C. for 30 minutes. In this manner, a negative electrode including a negative electrode layer and a negative electrode current collector was obtained.

### Production of Positive Electrode

A coated positive electrode active material containing a core particle (NCM: LiNi_{0.33}Co_{0.33}Mn_{0.33}O₂; average particle size: 6.0 μm) as a positive electrode active material, a layer of LiNbO₃ formed on the surface of the core particle (first coating layer), and a layer of a sulfide solid electrolyte (Li₂S—P₂S₅) formed on the surface of the first coating layer (second coating layer) was prepared.

The coated positive electrode active material, the sulfide solid electrolyte (SE: Li₂S—P₂S₅), a conductive aid (VGCF), a PVDF-based binder, and butyl butyrate were stirred in an ultrasonic dispersion device to produce a positive electrode slurry. Here, in the positive electrode slurry, the weight ratio between the positive electrode active material and the sulfide solid electrolyte was 80:20. This positive electrode slurry was applied by a blade method onto a positive electrode current collector, and the resultant was dried on a hot plate at 100° C. for 30 minutes. In this manner, a positive electrode including a positive electrode layer and a positive electrode current collector was obtained. As the positive electrode current collector, a current collector foil (current collector foil α) including an Al foil, and a carbon layer containing alumina (Al₂O₃) was used. The current collector foil a was prepared as follows. First, carbon, PVDF and Al₂O₃ were mixed in a composition of 10:60:30 to prepare a slurry. This slurry was applied onto a 15 μm Al foil, and the resultant was dried to form a carbon layer with a thickness of 1.5 μm on the Al foil.

In the production of the positive electrode and the production of the negative electrode, the ratio (capacity ratio) of a negative electrode capacity to a positive electrode capacity was adjusted to 2.5. The capacity ratio was obtained in accordance with the following equation (1):

$$\begin{matrix}[ Expression 1 ] & \\ Capacity Ratio = \frac{\begin{matrix}Specific Capacity of Negative \\ Electrode ( mAh / g ) \times Coating Weight of Negative \\ Electrode Mixture ( mg / {cm}^{2} ) \times Weight Ratio of \\ Negative Electrode Active Material ( wt \% )\end{matrix}}{\begin{matrix}Specific Capacity of Positive \\ Electrode ( mAh / g ) \times Coating Weight of Positive \\ Electrode Mixture ( mg / {cm}^{2} ) \times Weight Ratio of \\ Positive Electrode Active Material ( wt \% )\end{matrix}} & ( 1 )\end{matrix}$$

### Production of Battery for Evaluation

A sulfide solid electrolyte (Li₂S—P₂S₅), a PVDF-based binder, and butyl butyrate were stirred in an ultrasonic dispersion device to produce a solid electrolyte slurry. Here, the weight ratio in the solid electrolyte slurry of the sulfide solid electrolyte: the PVDF-based binder was adjusted to 99.4:0.4. This solid electrolyte slurry was applied by a blade method onto a substrate (Al foil), and the resultant was dried. In this manner, a transfer member including a sulfide solid electrolyte layer (thickness: 30 μm) and the substrate was obtained.

The transfer member and the positive electrode were stacked so as to have the sulfide solid electrolyte layer and the positive electrode layer contacting each other, the resultant was pressed, and the substrate (Al foil) of the transfer member was peeled off to obtain a laminate. Next, the laminate and the negative electrode were stacked so as to have the sulfide solid electrolyte layer and the negative electrode layer contacting each other, and the resultant was pressed. Thus, a battery for evaluation was produced.

### Example 1-2 and Example 1-3

Batteries for evaluation were produced in the same manner as in Example 1-1 except that the positive electrode and the negative electrode were produced with the capacity ratio adjusted to a value shown in Table 1.

### Comparative Examples 1-1 to 1-3

Batteries for evaluation were produced respectively in the same manner as in Examples 1-1 to 1-3 except that Si particles having a diamond crystalline phase (crystalline Si: Si powder having no pore inside a primary particle) were used as the negative electrode active material.

### Evaluation 1

Observation with Microscope

The negative electrode active materials produced in Examples 1-1 to 1-3 were observed with a scanning electron microscope (SEM) to obtain photographs of particles. Specifically, the negative electrode layer was subjected to ion milling to expose a section, and the section was observed with an SEM. As a result, it was confirmed that there was a pore inside the primary particle of the negative electrode active material. XRD Measurement

The negative electrode active materials produced in Examples 1-1 to 1-3 were subjected to X-ray diffraction (XRD) measurement using CuKα ray. As a result, it was confirmed that all the negative electrode active materials had, as a main phase, a type II silicon clathrate crystalline phase.

### Nail Penetration Test

First, the produced battery for evaluation was charged until SOC became 100%. Specifically, CC charge was performed at ⅓ C up to 4.05 V, and thereafter, CV charge was performed at 4.05 V up to 1/100 C.

Next, the charged battery was subjected to a nail penetration test, specifically, subjected to a DISC test with monitoring a battery voltage, a nail potential, and a sneak current, and based on the change of the voltage and current at the occurrence of a short circuit, a calorific value was calculated.

The calorific value of Example 1-1 was relatively evaluated assuming that the calorific value of Comparative Example 1-1 was 100%. Examples 1-2 and 1-3 were similarly relatively evaluated respectively assuming that the calorific values of Comparative Examples 1-2 and 1-3 were 100%. Results are shown in Table 1.

TABLE 1

| | Capacity | Negative Electrode | Calorific |
|---|---|---|---|
| | Ratio | Active Material | Value (%) |
| Comparative Example 1-1 | 2.5 | Crystalline Si | 100.0 |
| Example 1-1 | | pc-Si | 9.0 |
| Comparative Example 1-2 | 3.5 | Crystalline Si | 100.0 |
| Example 1-2 | | pc-Si | 11.0 |
| Comparative Example 1-3 | 5.0 | Crystalline Si | 100.0 |
| Example 1-3 | | pc-Si | 11.3 |

As shown in Table 1, it was confirmed that the calorific value is remarkably suppressed in the batteries of the present disclosure.

### Comparative Example 1-4

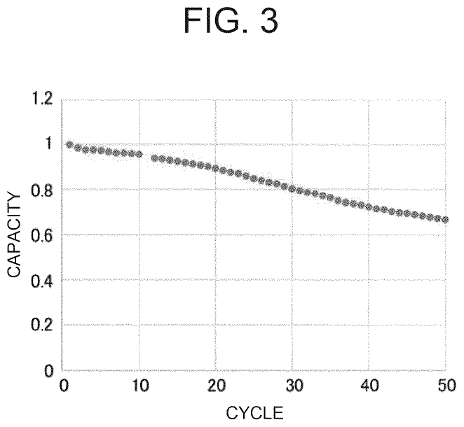

A battery for evaluation was produced in the same manner as in Example 1-1 except that the capacity ratio was changed to 2.4. The produced battery for evaluation was subjected to a cycle test. As conditions for the cycle test, CCCV charge-discharge was performed with an upper limit voltage of 4.55 V and a lower limit voltage of 2.5 V at 0.1 C for 50 cycles. Change of the capacity based on a charge capacity of the 1st cycle was calculated. Results are illustrated in FIG. 3.

As illustrated in FIG. 3, the capacity of the 50th cycle was reduced to about 65% of the capacity of the 1st cycle. Although not illustrated in drawings, the batteries of Examples 1-1 to 1-3 were subjected to the cycle test, and were found to have the capacity of the 50th cycle corresponding to 80% or more of the capacity of the 1st cycle.

### Example 2-1

A battery for evaluation having a capacity ratio of 3.5 was produced as follows.

### Production of Negative Electrode

A negative electrode slurry was produced in the same manner as in Example 1-1 except that the weight ratio between the negative electrode active material (pc-Si) and the sulfide solid electrolyte was changed to 55:45. A negative electrode was produced in the same manner as in Example 1-1 except that this negative electrode slurry was used.

### Production of Positive Electrode

A coated positive electrode active material having the first coating layer but not having the second coating layer (core particle: NCA; LiNi_{0.8}CO_{0.15}Al_{0.05}O₂; average particle size: 4.5 μm) used as a positive electrode active material, a sulfide solid electrolyte (SE: Li₂S—P₂S₅), a conductive aid (VGCF), a PVdF-based binder, and butyl butyrate were stirred in an ultrasonic dispersion device to produce a positive electrode slurry. Here, the weight ratio in the positive electrode slurry between the positive electrode active material and the sulfide solid electrolyte was 75:25. A positive electrode was produced in the same manner as in Example 1-1 except that this positive electrode slurry was used.

A battery for evaluation was produced in the same manner as in Example 1-1 except that the negative electrode and the positive electrode, and a transfer member having a sulfide solid electrolyte layer with a thickness of 15 μm were used.

### Example 2-2

A battery for evaluation was produced in the same manner as in Example 2-1 except that the thickness of the electrolyte layer was changed to 30 μm.

### Example 2-3

A polyester nonwoven fabric was placed on a substrate (Al foil), the solid electrolyte slurry was applied onto the nonwoven fabric by a blade method, and the resultant was dried. Thus, a transfer member including the nonwoven fabric, and having a solid electrolyte layer with a thickness of 30 μm was obtained. A battery for evaluation was produced in the same manner as in Example 2-1 except that this transfer member was used.

### Example 2-4

A resin (polyethylene), a conductive aid (VGCF), and a solvent (butyl butyrate) were mixed to prepare a resin slurry. The ratio (weight ratio) between the resin and the conductive aid was 80:20. This resin slurry was applied onto an Al foil, and the resultant was dried to produce a current collector of a resin-coated Al foil. A battery for evaluation was produced in the same manner as in Example 2-1 except that the resin-coated Al foil (current collector foil β) was used as the positive electrode current collector.

### Example 2-5

A battery for evaluation was produced in the same manner as in Example 2-1 except that a coated positive electrode active material having a first coating layer and a second coating layer (core particle: NCA; LiNi_{0.8}Co_{0.15}Al_{0.05}O₂; average particle size: 3.0 μm) was used as the positive electrode active material.

### Example 2-6

A battery for evaluation was produced in the same manner as in Example 2-1 except that the weight ratio in the positive electrode slurry between the positive electrode active material and the sulfide solid electrolyte was changed to 70:30.

### Example 2-7

A resin (acrylic-based resin), a conductive aid (carbon black), a dispersant and a solvent (water and isopropanol) were mixed to prepare a resin slurry. The ratio (weight ratio) among the resin, the conductive aid, and the dispersant was 70:25:5. This resin slurry was applied onto an Al foil, and the resultant was dried to produce a resin-coated Al foil (current collector foil γ). The positive electrode was produced in the same manner as in Example 2-5 except that the current collector foil γ was used as the positive electrode current collector.

A negative electrode including two negative electrode layers different from each other in the weight ratio between a negative electrode active material and a sulfide solid electrolyte was produced. Specifically, a negative electrode having a first negative electrode layer and a second negative electrode layer arranged from the side of a negative electrode current collector was produced. Here, the weight ratio between the negative electrode active material and the sulfide solid electrolyte in the first negative electrode layer was 55:45, and the weight ratio between the negative electrode active material and the sulfide solid electrolyte in the second negative electrode layer was 45:55.

A battery for evaluation was produced in the same manner as in Example 2-1 except that the positive electrode and the negative electrode were used.

### Example 2-8

A negative electrode was produced in the same manner as in Example 2-7. A battery for evaluation was produced in the same manner as in Example 2-5 except that this negative electrode was used.

### Example 2-9

A negative electrode and a battery for evaluation were produced in the same manner as in Example 2-7 except that the weight ratio between the negative electrode active material and the sulfide solid electrolyte in the first negative electrode layer was changed to 60:40.

### Example 2-10

A battery for evaluation was produced in the same manner as in Example 2-9 except that the positive electrode current collector was changed to the current collector foil a.

### Evaluation 2

### Nail Penetration Test

The produced batteries for evaluation were subjected to a nail penetration test in the same manner as in Evaluation 1 to evaluate the calorific value. The calorific value was relatively evaluated assuming that the calorific value of Example 2-1 was 100%. Results are shown in Table 2. It is noted that Table 2 also shows the calorific values of Comparative Examples 1-1 to 1-3 in comparison with that of Example 2-1.

TABLE 2

| | Positive Electrode | | | | | | Negative Electrode | | | | |
|---|---|---|---|---|---|---|---|---|---|---|---|
| | | | Electrode | | | | | Electrode | | | |
| | | | Ratio | | | | | Ratio | | | |
| | | | (wt %) | | Second | Current | | (wt %) | | Electrolyte | Calorific |
| | Active | Particle | Active | | Coating | Collector | Active | Active | | Layer | Value |
| | Material | Size | Material | SE | Layer | Foil | Material | Material | SE | Thickness | (%) |
| Example 2-1 | NCA | 4.5 μm | 75 | 25 | Not | α | pc-Si | 55 | 45 | 15μm | 100.0 |
| | | | | | Included | | | | | | |
| Example 2-2 | NCA | 4.5 μm | 75 | 25 | Not | α | pc-Si | 55 | 45 | 30 μm | 85.2 |
| | | | | | Included | | | | | | |
| Example 2-3 | NCA | 4.5 μm | 75 | 25 | Not | α | pc-Si | 55 | 45 | 30 μm | 26.2 |
| | | | | | Included | | | | | Nonwoven | |
| | | | | | | | | | | Fabric | |
| Example 2-4 | NCA | 4.5 μm | 75 | 25 | Not | β | pc-Si | 55 | 45 | 15 μm | 61.2 |
| | | | | | Included | | | | | | |
| Example 2-5 | NCA | 3.0 μm | 75 | 25 | Included | α | pc-Si | 55 | 45 | 15 μm | 98.9 |
| Example 2-6 | NCA | 4.5 μm | 70 | 30 | Not | α | pc-Si | 55 | 45 | 15 μm | 79.8 |
| | | | | | Included | | | | | | |
| Example 2-7 | NCA | 3.0 μm | 75 | 25 | Included | γ | pc-Si | Bilayer | | 15 μm | 71.6 |
| | | | | | | | | Negative | | | |
| | | | | | | | | Electrode | | | |
| Example 2-8 | NCA | 3.0 μm | 75 | 25 | Included | α | pc-Si | Bilayer | | 15 μm | 69.4 |
| | | | | | | | | Negative | | | |
| | | | | | | | | Electrode | | | |
| Example 2-9 | NCA | 3.0 μm | 75 | 25 | Included | γ | pc-Si | Bilayer | | 15 μm | 79.8 |
| | | | | | | | | Negative | | | |
| | | | | | | | | Electrode | | | |
| Example | NCA | 3.0 μm | 75 | 25 | Included | α | pc-Si | Bilayer | | 15 μm | 74.9 |
| 2-10 | | | | | | | | Negative | | | |
| | | | | | | | | Electrode | | | |
| Comparative | NCM | 6.0 μm | 80 | 20 | Included | α | Crystalline | 65 | 35 | 30 μm | 950.8 |
| Example 1-1 | | | | | | | Si | | | | |
| Comparative | NCM | 6.0 μm | 80 | 20 | Included | α | Crystalline | 65 | 35 | 30 μm | 1830.6 |
| Example 1-2 | | | | | | | Si | | | | |
| Comparative | NCM | 6.0 μm | 80 | 20 | Included | α | Crystalline | 65 | 35 | 30 μm | 300.5 |
| Example 1-3 | | | | | | | Si | | | | |

As shown in Table 2, it was confirmed that the calorific value is further suppressed by adjusting the conditions of the positive electrode layer and the positive electrode current collector, the conditions of the electrolyte layer, and the layer configuration of the negative electrode layer. This suggests possibility that the calorific value can be synergistically suppressed by adjusting respective conditions of a battery.

What is claimed is:

1. A battery comprising:
a positive electrode layer containing a positive electrode active material;
a negative electrode layer containing a negative electrode active material; and
an electrolyte layer containing an electrolyte, and disposed between the positive electrode layer and the negative electrode layer,
wherein the negative electrode layer contains a Si-based negative electrode active material as the negative electrode active material,
the Si-based negative electrode active material has a pore inside a primary particle, and
a ratio of a negative electrode capacity to a positive electrode capacity is 2.5 or more.

2. The battery according to claim 1, wherein the ratio is 5.0 or less.

3. The battery according to claim 1, wherein the Si-based negative electrode active material has a silicon clathrate crystalline phase.

4. The battery according to claim 3, wherein the Si-based negative electrode active material has, as the crystalline phase, a type II silicon clathrate crystalline phase.

5. The battery according to claim 1, wherein a proportion of the Si-based negative electrode active material in the negative electrode layer is 45% by weight or more.
